(19) United States
(12) Patent Application Publication
(10) Pub. No.: US 2014/0175175 A1
(43) Pub. Date: Jun. 26, 2014

(54) READER FOR BARCODE AND PACKAGE PROCESSING SYSTEM USING SAME

(71) Applicants: Hon Hai Precision Industry Co., Ltd., New Taipei (TW); Hong Fu Jin Precision Industry (ShenZhen) Co., Ltd, Shenzhen (CN)

(72) Inventors: ZONG-YUAN SUN, New Taipei (TW); DA-HUA XIAO, Shenzhen (CN)

(73) Assignees: HON HAI PRECISION INDUSTRY CO., LTD., New Taipei (TW); Hong Fu Jin Precision Industry (ShenZhen) Co., Ltd, Shenzhen (CN)

(21) Appl. No.: 13/974,157

(22) Filed: Aug. 23, 2013

(30) Foreign Application Priority Data
Dec. 24, 2012 (CN) 2012105654440

(51) Int. Cl. G06K 7/10

(52) U.S. Cl. CPC G06K 7/10881
USPC 235/462.49

(57) ABSTRACT

A pen-sized barcode reader includes a shell, a button, and a control unit. The control unit is received in the shell, and is activated by the button. The control unit includes a barcode scanning module, a microcontroller, and a near field communication (NFC) unit. The barcode scanning module scans the barcodes of goods to obtain barcode information. The microcontroller decodes the barcode information. The NFC unit sends the barcode information decoded by the microcontroller to a local portable electronic device and the serial number plus other transit information such as current location and destination are transmitted to a central server by the local portable electronic device.

### BACKGROUND

1. Technical field

The disclosure generally relates to barcode readers and particularly to a package processing system using the same.

2. Description of the Related Art

Readers for barcodes are common in businesses. The reader may scan the barcodes to obtain a package serial number. Additionally, related package information (for example, destination or telephone numbers) can be edited through the reader, and then the package serial number and the related package information are sent to a terminal server via a global positioning system (GPS) unit. However, such a reader is not easy to carry, and the GPS function may consume a lot of power.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic view of a reader used in a package processing system, according to an exemplary embodiment.

FIG. 2 is a block diagram of the package processing system as shown in FIG. 1.

### DETAILED DESCRIPTION

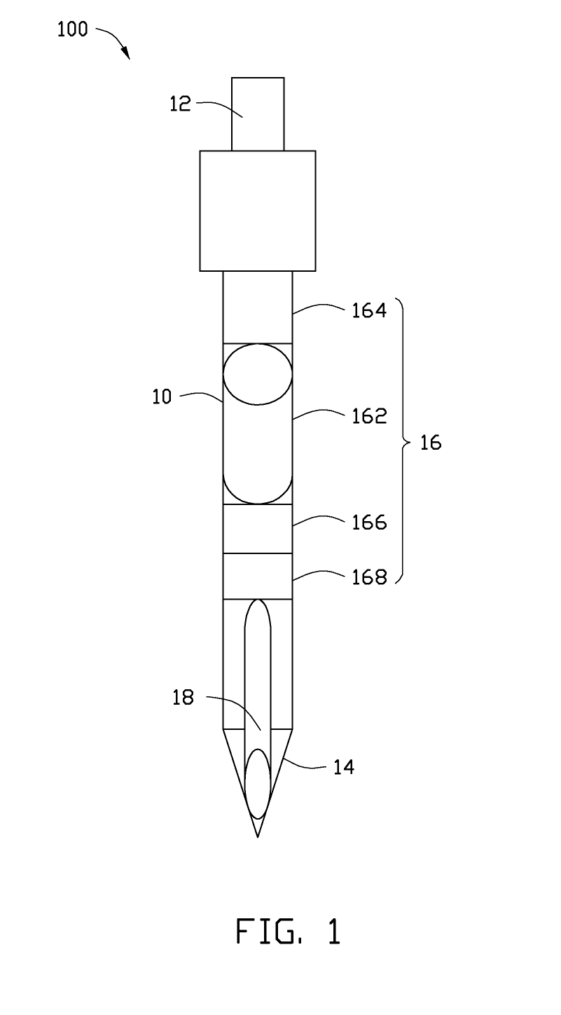

FIG. 1 is a schematic view of a reader 100, according to an exemplary embodiment. In one exemplary embodiment, the reader 100 is used in a package business. The reader 100 scans barcodes on a package bill to obtain information such as a package serial number.

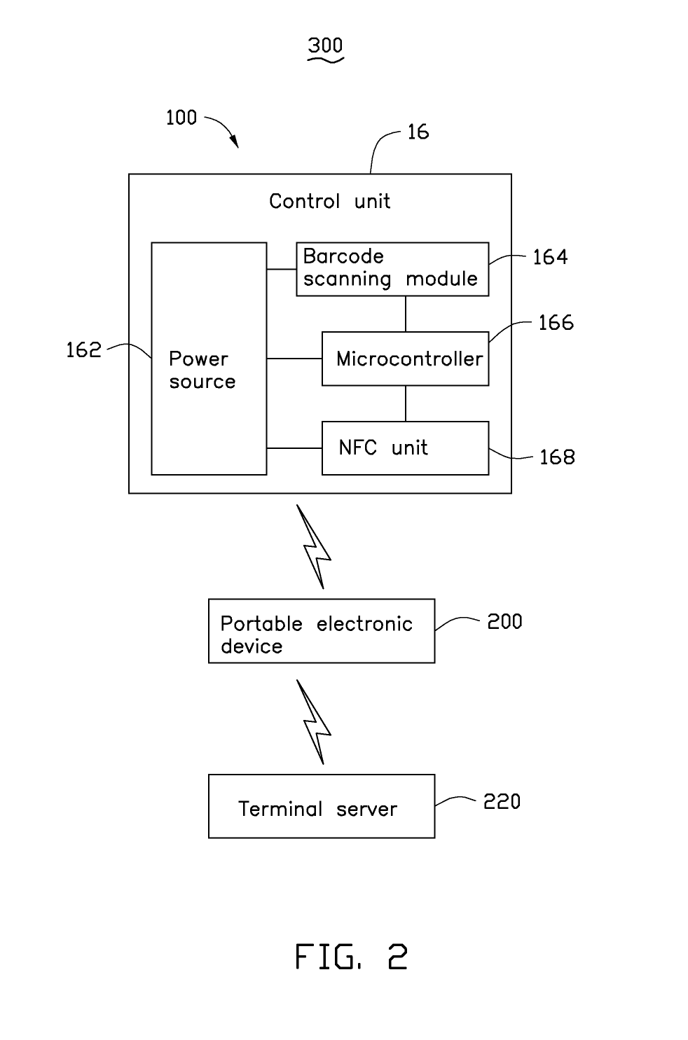

Referring to FIG. 2, the reader 100 communicates with a portable electronic device 200, such as a mobile phone, for example. The portable electronic device 200 is in communication with a terminal server 220 located at a package company. The reader 100, the portable electronic device 200, and the terminal server 220 cooperatively form a package processing system 300.

In one exemplary embodiment, the reader 100 is substantially pen-shaped, and includes a hollow shell 10, a button 12, a nib 14, a control unit 16, and a pen body 18. The button 12 and the nib 14 are located at two opposite ends of the hollow shell 10. The pen body 18 is received in the hollow shell 10, and slides in or out of the hollow shell 10 by manipulation of the button 12.

The control unit 16 is received in the hollow shell 10, and is activated by the button 12. The control unit 16 includes a power source 162, a barcode scanning module 164, a microcontroller 166, and a near field communication (NFC) unit 168. The barcode scanning module 164, the microcontroller 166, and the NFC unit 168 are all electronically connected to the power source 162 to receive power. When the button 12 is actuated, the control unit 16 enters into a working state or an idle state.

In one exemplary embodiment, the barcode scanning module 164 is an infrared photoelectric sensor, which is positioned adjacent to the button 12. The barcode scanning module 164 scans the barcodes on the package bill to obtain barcode information. The microcontroller 166 is electronically connected between the barcode scanning module 164 and the NFC unit 168. The microcontroller 166 decodes the barcode information into a package serial number, and transmits the package serial number to the NFC unit 168. In one exemplary embodiment, the NFC unit 168 is a BLUETOOTH module, which communicates with the portable electronic device 200 to send the package serial number to the portable electronic device 200.

The control unit 16 is received in the hollow shell 10 and the reader 100 is entirely portable.

At least one program or other software is installed in the portable electronic device 200 in relation to the package business, to edit related package information (for example, destinations or telephone numbers). Both the package serial number received from the reader 100 and the related package information are sent to the terminal server 220 via a wireless communication network, such as 2G/3G network, for example.

In other exemplary embodiments, the pen body 18 is permanently extended from the hollow shell 10, and is not directed by the button 12.

In other exemplary embodiments, the NFC unit 168 is a WIFI module. Both the BLUETOOTH module and the WIFI module have short transmission distances and low power consumption. Thus, the reader 100 conserves power.

In use, the button 12 is actuated to activate the control unit 16. The barcode scanning module 164 scans the barcodes on the package bill to obtain barcode information. The microcontroller 166 decodes the barcode information, obtains the package serial number, and passes the package serial number to the NFC unit 168. The NFC unit 168 sends the package serial number to the portable electronic device 200. The button 12 can be actuated again to deactivate the control unit 16.

The related package information including destination or telephone numbers is written by hand on the package bill via the pen body 18, or the related package information is directly edited on the portable electronic device 200, so that the related package information and the package serial number received from the reader 100 can be sent to the terminal server 220.

The reader 100 communicates with the portable electronic device 200 via the NFC unit 168, allowing the package serial number to be wirelessly transmitted to the portable electronic device 200, and the related package information can be included, and edited, on the portable electronic device 200. The reader 100 requires minimal power.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of the exemplary disclosure to the full extent indicated by the broad general meaning of the terms in which the appended claims are expressed.

What is claimed is:

1. A package electronic reader device, comprising:
a shell;
a button disposed on the shell; and
a control unit received in the shell and activated by the button, the control unit comprising:
a barcode scanning module scanning the barcodes to obtain barcode information of the barcodes;
a microcontroller decoding the barcode information; and
a near field communication (NFC) unit sending the barcode information decoded by the microcontroller to a portable electronic device.

2. The reader as claimed in claim 1, wherein the reader is substantially pen-shaped.

3. The reader as claimed in claim 2, further comprising a nib, wherein the nib and the button are located at two opposite ends of the shell.

4. The reader as claimed in claim 3, further comprising a pen body, wherein the pen body is received in the shell, and slides in or out of the hollow shell by manipulation of the button.

5. The reader as claimed in claim 1, wherein the NFC unit is a BLUETOOTH module or a wireless fidelity (WIFI) module.

6. The reader as claimed in claim 1, wherein the microcontroller decodes the barcode information into a package serial number.

7. A package processing system comprising a reader in communication with a portable electronic device, the reader comprising a control unit, the control unit comprising:
a barcode scanning module scanning barcodes to obtain barcode information;
a microcontroller decoding the barcode information; and
a near field communication (NFC) unit sending the barcode information decoded by the microcontroller to the portable electronic device.

8. The package processing system as claimed in claim 7, wherein the microcontroller decodes the barcode information into a package serial number, and the NFC sends the package serial number to the portable electronic device.

9. The package processing system as claimed in claim 8, further comprising a terminal server in communication with the portable electronic device, wherein related package information is edited on the portable electronic device, and the portable electronic device sends the related package information and the package serial number to the terminal server.

10. The package processing system as claimed in claim 7, wherein the reader is substantially pen-shaped.

11. The package processing system as claimed in claim 10, wherein the reader comprises a shell and a button, the control unit is received in the shell and is activated by the button.

12. The package processing system as claimed in claim 11, wherein the reader comprises a nib, wherein the nib and the button are located at two opposite ends of the shell.

13. The package processing system as claimed in claim 12, wherein the reader comprises a pen body, wherein the pen body is received in the shell, and slides in or out of the hollow shell by manipulation of the button.

14. The package processing system as claimed in claim 7, wherein the NFC unit is a BLUETOOTH module or a WIFI module.
